(19) United States
(12) Patent Application Publication
(10) Pub. No.: US 2019/0161365 A1
(43) Pub. Date: May 30, 2019

(54) Device for Separating Product Water From Impure Raw Water

(71) Applicant: Siemens Aktiengesellschaft, Muenchen (DE)

(72) Inventors: Andreas Büttner, Stolzenberger Hof (DE); Thomas Hammer, Hemhofen (DE); Markus Ungerer, Baiersdorf (DE)

(73) Assignee: Siemens Aktiengesellschaft, Muenchen (DE)

(21) Appl. No.: 16/320,855

(22) PCT Filed: Jul. 6, 2017
(86) PCT No.: PCT/EP2017/066851

§ 371 Date: Jan. 25, 2019

(30) Foreign Application Priority Data
Jul. 29, 2016 (DE) 10 2016 214 019.1

(51) Int. Cl. C02F 1/04; C02F 1/10; B01D 5/00

(52) U.S. Cl. CPC C02F 1/048; B01D 1/14; B01D 5/009; C02F 1/10

(57) ABSTRACT

Some embodiments may include a device for separating product water which is obtained by condensation from raw water comprising a mixture of water and impurities comprising: a gas process circuit for a process gas, including an evaporator for the raw water and a condenser for the product water connected in series; and a product water process circuit including the condenser and a first heat exchanger for cooling the product water connected in series. The evaporator comprises an inlet for the raw water and an outlet for a concentrate which as compared to the raw water has a higher concentration of impurities to be separated. The condenser comprises an inlet for the product water in a top of the condenser and the outlet for the product water in a bottom of the condenser. The process gas flows from the bottom of the condenser to the top of the condenser.

### CROSS-REFERENCE TO RELATED APPLICATIONS

This application is a U.S. National Stage Application of International Application No. PCT/EP2017/066851 filed Jul. 6, 2017, which designates the United States of America, and claims priority to DE Application No. 10 2016 214 019.1 filed Jul. 29, 2016, the contents of which are hereby incorporated by reference in their entirety.

### TECHNICAL FIELD

The present disclosure relates to water treatment. Various embodiments may include a device for separating product water which is obtained by condensation from raw water which is composed of a mixture of water and impurities.

### BACKGROUND

A device and a purifying method suitable for said device are known and can be derived, for example, from DE 10 2014 217 281 A1. The functioning mode of the device and of the method according to said document are also described in more detail by means of FIG. 1. This method operates according to the principle of the convectively supported evaporation of water in a downdraft evaporator in counterflowing air. The temperature of the water flowing downward in the evaporator drops from the top to the bottom since water is extracted by evaporation and heat transfer to the counterflowing air. The pure product in the form of water vapor is then fully condensed in a condenser that may be cooled by the raw water, wherein the evaporation heat released herein is fed to the raw water.

The humidified gas flow can be fed to a tube-bundle heat exchanger for example so as to cool therein and fully condense the product water. This design permits a direct use of the raw water as a cooling medium so as to guarantee an internal heat recovery. However, heat exchangers designed in such a manner as a matter of principle have a heat transfer through the walls of the tubes, said heat transfer being limited on account of the configuration of a gas layer that is deprived of water vapor in the proximity of the surface of the heat exchanger. Moreover, a water layer which allows the creation of an additional resistance to heat transfer is created on the surface of the tubes. Moreover, depending on the impurities in the raw water, corrosion-resistant materials which increase the cost of the apparatus have to be selected. This is a consequence of both the high temperatures as well as the high content of oxygen of the media. Moreover, a pH value below 7 arises in the condensate on account of the presence of CO₂, this further facilitating corrosion. An intense corrosive invasion also has to be taken into account when low-molecular-weight organic acids or ammonia are part of the impurities. The use of iron-based or copper-based materials which have positive heat conducting properties is therefore considered to be problematic. Plastic-based condensers could be used instead, this however being associated with the disadvantage of having a significantly lower heat transfer. The condenser in this case has to be conceived so as to be significantly larger.

### SUMMARY

Some embodiments may include a device for separating product water which is obtained by condensation from raw water which is composed of a mixture of water and impurities, in which device: a gas process circuit (11) for a process gas is provided, in which an evaporator (13) for the raw water and a condenser (14) for the product water are connected in series; the evaporator (13) has an infeed (23) for the raw water and an outfeed (24) for a concentrate which as compared to the raw water has a higher concentration of impurities to be separated; the condenser (14) has an outlet (31) for the product water; characterized in that: a product water process circuit (33) is provided, in which the condenser (14) and a first heat exchanger (35) for cooling the product water are connected in series; and the condenser (14) is embodied in a construction principle of direct condensation, wherein an inlet (34) for the product water is provided in a top (29) of the condenser (14), and the outlet (31) for the product water is provided in a bottom (30) of the condenser (14), and a flow direction from the bottom (30) of the condenser (14) to the top (29) of the condenser (14) is provided for the process gas.

In some embodiments, the evaporator (13) is embodied in a construction principle in which the infeed (23) for the raw water is provided in a top (19) of the evaporator (13), and the outfeed (24) for the concentrate is provided in a bottom (22) of the evaporator (13), and a flow direction from the bottom (22) of the evaporator (13) to the top (19) of the evaporator (13) is provided for the process gas; and the gas process circuit (11) is routed such that the top (29) of the condenser (14) is connected to the bottom (22) of the evaporator (13), and the top (19) of the evaporator (13) is connected to the bottom (30) of the condenser (14).

In some embodiments, the first heat exchanger (35) for cooling the product water is connected to a line for the raw water, wherein the line upon passing through the first heat exchanger (35) is routed to the infeed (23) of the evaporator.

In some embodiments, a second heat exchanger (17) is provided in the line between the first heat exchanger (35) and the infeed (23).

In some embodiments, a third heat exchanger is provided in the product water process circuit (33) between the first heat exchanger (35) and the inlet (34).

In some embodiments, the evaporator (13) and/or the condenser (14) are/is constructed so as to be multi-staged.

In some embodiments, the device is constructed from a plurality of stages (39a, 39b) in that a plurality of evaporators (13a, 13b) and condensers (14a, 14b) in pairs are in each case equipped with one product water process circuit (33a, 33b) and one gas process circuit (11a, 11b), wherein the stages (39a, 39b) are capable of being operated at different temperatures; the product water process circuits (33a, 33b) of neighboring stages are connected to a first connection line (41); and a second connection line (40) is provided between the bottom (22) of one of the evaporators (11a, 11b) of a stage (39a, 39b) having a lower temperature level and the top (19) of one of the evaporators (11a, 11b) of a neighboring stage (39a, 39b) having a higher temperature level.

In some embodiments, one third heat exchanger (36) is in each case disposed in each of the product water process circuits (33a, 33b), wherein the third heat exchangers (36) of neighboring stages (39a, 39b) are in each case connected by a third connection line (43).

In some embodiments, one second heat exchanger (17) is in each case disposed in each of the lines leading to the evaporators (12a, 12b), wherein the second heat exchangers (17) of neighboring stages (39a, 39b) are in each case connected by a fourth connection line (18).

As another example, some embodiments include a method for separating product water which is obtained by condensation from raw water which is composed of a mixture of water and impurities, in which method a gas process circuit (11) is operated by way of a process gas, in which an evaporator (13) for the raw water and a condenser (14) for the product water are connected in series; the evaporator (13) by way of an infeed (23) is impinged with the raw water, and a concentrate which as compared to the raw water has a higher concentration of impurities to be separated is retrieved by way of an outfeed (24) of the evaporator (13); product water is retrieved from the condenser (14) by way of an outlet (31); characterized in that a product water process circuit (33) is provided, in which the condenser (14) and a first heat exchanger (35) for cooling the product water are connected in series; and direct condensation is carried out in the condenser (14), wherein the product water is fed by way of an inlet (34) into a top (29) of the condenser (14), and the outlet for the product water (31) is provided in a bottom (30) of the condenser (14), and the process gas flows in the direction from the bottom (30) of the condenser (14) to the top (29) of the condenser (14).

In some embodiments, a device as described above is applied.

In some embodiments, the method is carried out in a plurality of stages (39a, 39b) in that a plurality of evaporators (11a, 11b) and condensers (14a, 14b) having in each case one product water process circuit (33a, 33b) and one gas process circuit (11a, 11b) are operated in pairs, wherein the stages (39a, 39b) are operated at different temperatures; the product water process circuits (33a, 33b) of neighboring stages (39a, 39b) are connected to a first connection line (41), wherein product water is transferred from the cooler to the hotter stage (39a, 39b); and a second connection line (40) is provided between the bottom (22) of one of the evaporators (11a, 11b) of a stage (39a, 39b) having a lower temperature level and the top (19) of one of the evaporators (11a, 11b) of a neighboring stage (39a, 39b) having a higher temperature level, wherein raw water is transferred from the cooler to the hotter stage (39a, 39b).

### BRIEF DESCRIPTION OF THE DRAWINGS

Further details of the teachings herein are described hereunder by means of the drawings. Identical or equivalent drawing elements are in each case provided with the same reference signs and are explained multiple times only in as far as there are points of differentiation between the figures in which:

FIG. 1 shows a device for separating product water from raw water according to the prior art, a method for separating product water from raw water running on said device, as a schematic block diagram;

FIG. 2 shows an exemplary embodiment of the device incorporating teachings of the present disclosure and a method running on said device as a block diagram; and

FIG. 3 shows an embodiment of a device incorporating the teachings herein, having two stages, and an embodiment of a multi-stage method running on said device, as a block diagram.

The devices and the methods running thereon are always simultaneously described hereunder. The device and the method are in each case closely interlinked such that the features described apply in each case simultaneously to the device and the method.

### DETAILED DESCRIPTION

Devices incorporating the teachings of the present disclosure may include a gas process circuit for a process gas, and in which an evaporator for the raw water and a condenser for the product water are connected in series, that is to say passed in an alternating manner. Moreover, the evaporator may have an infeed for the raw water and an outfeed for a concentrate, wherein the concentrate as compared to the raw water has a higher concentration of impurities to be separated. The impurities to be separated do not have a lower boiling point than water and therefore remain in the raw water. Impurities which are more volatile than water and remain in the concentrate can also be contained in the raw water; however, said impurities are not to be separated by the method described and not considered hereunder when reference is made of concentrating the impurities. The volatile impurities are nevertheless of technical relevance since said volatile impurities render product water to a corrosive medium. The product water is discharged by way of an outlet of the condenser.

In some embodiments, there is a method for separating product water which is obtained by condensation from raw water which is composed of a mixture of water and impurities. In some embodiments, a gas process circuit is operated by way of a process gas, wherein an evaporator for the raw water and a condenser for the product water are connected in series in said gas process circuit. The evaporator by way of an infeed is impinged with the raw water, and a concentrate which as compared to the raw water has a higher concentration of impurities to be separated is retrieved by way of an outfeed in the evaporator. Purified product water can then be retrieved from the condenser by way of an outlet.

In some embodiments, a device, or a method, respectively, enables an efficient condensation of the product water, on the one hand, and is immune in relation to the corrosive properties of the condensate, on the other hand. In some embodiments, the condenser is embodied in a construction principle of direct condensation. This means that the product water from the gas flow is directly condensed in that cooling water is brought into direct contact with the gas flow in the gas process circuit in the condenser.

In some embodiments, a product water process circuit includes the condenser and a first heat exchanger for cooling the product water connected in series. This means that the cooled product water per se is used as cooling water. Therefore, an inlet in a top of the condenser, and an outlet in a bottom of the condenser, are provided for the product water. A flow direction from the bottom of the condenser to the top of the condenser (thus directed counter to the gas flow) is provided for the process gas in the condenser.

In an analogous manner, a product water process circuit in which the condenser and a first heat exchanger for cooling the product water are connected in series, thus are passed in an alternating manner, is provided. Direct condensation as a result of the construction mode is carried out in the condenser in that the cool product water is fed by way of an inlet into the top of the condenser, and the product water by way of an outlet in a bottom of the condenser is discharged again. The process gas flows in the direction from the bottom of the condenser to the top of the condenser such that said process gas is cooled in the counter flow by the infed liquid product water and herein condenses product water from the process gas. More product water is thus retrieved from the condenser than is fed thereinto.

As has already been mentioned, the cooling water and the humid air flow, or the condensate, respectively, come into direct contact (principle of direct condensation). A heat transfer via a separate medium is therefore not required, on account of which the efficiency of cooling is at least somewhat increased. Moreover, the surface for condensing is made available by the product water per se, on account of which a corrosive invasion can be precluded.

Just as is the case in the evaporator, a surface that is as large as possible may be provided for an efficient exchange of substance and heat. The cooling water can be injected and/or atomized into the condenser, for example. The droplet size herein can be set such that the droplets are sufficiently small so as to provide a surface sufficient for the heat transfer but sufficiently large so as not to cause any unnecessary investment in terms of energy in the atomization. A further possibility lies in the use of a packing such as this also can be used in the evaporator. The packing serves for enlarging the surface and is impinged with a film of the product water which simultaneously protects the surface of the packing from corrosion while a direct heat transfer into the product water is performed.

In some embodiments, the cooling water which is introduced into the condenser comes into direct contact with the product water which is condensed from the gas process circuit. Therefore, said cooling water may be of at least the same quality. This is the reason for the measure of cooling the product water and of making the latter available to the condenser as cooling water in a process circuit. The quantity of product water condensed herein can be retrieved from the process circuit.

In some embodiments, the evaporator in a manner known per se is embodied in a construction principle in which the raw water and the gas of the gas process circuit flow in opposite directions, on account of which said raw water partially evaporates and a concentration of impurities takes place in the remaining raw water. The infeed for the raw water is provided in the top of the evaporator, and the outfeed for the concentrate is provided in a bottom of the evaporator, said concentrate being able to be retrieved from the process in this manner or in a process circuit being able to be re-fed as raw water to the evaporator at the top. However, the conception of such a process circuit is not necessarily required. A flow direction from the bottom of the evaporator to the top of the evaporator is provided for the process gas in the evaporator. Moreover, the gas process circuit may be routed such that the top of the condenser is connected to the bottom of the evaporator, and the top of the evaporator is connected to the bottom of the condenser. It is ensured on account thereof that process gas flows in each case through both the evaporator as well as the condenser from bottom to top in order for the process gas to be able to pass through the liquid that flows or drops from top to bottom. The profile of the gas flow to this extent can be described as a figure of eight.

Another advantage of using a condenser according to the construction principle of direct condensation lies in that identical or at least similar construction components can be used for manufacturing the condenser and the evaporator. This simplifies and reduces the cost of the production and therefore has economic advantages. While a further heat exchanger has indeed to be provided in the product water process circuit because of direct condensation being applied, this additional investment may be however less than the simplification of the construction of the condenser in which the use of expensive materials can in particular be minimized.

In some embodiments, the first heat exchanger for cooling the product water is connected to a line for the raw water, wherein the line upon passing through the first heat exchanger is routed to the infeed of the evaporator. As has already been mentioned, said line can be part of a process circuit, wherein the raw water in the line is at least in part retrieved as concentrate from the evaporator. In any case, the use of the raw water for cooling the product water enables at least part of the required heat to be absorbed in order for said raw water in the evaporator to be able to be converted into a gaseous state. The required evaporation heat has to be applied herein.

In some embodiments, further heating of the raw water can be performed by way of a second heat exchanger in the line between the first heat exchanger and the infeed. To this extent, the first heat exchanger in the case of this embodiment serves only for pre-heating the raw water which in the second heat exchanger absorbs, for example, process heat which is created as waste in any arbitrary process. This exhaust heat can be created, for example, in the case of industrial processes or in the case of the generation of energy and therefore leads to a favorable energy balance when carrying out the method or using the device.

In some embodiments, a third heat exchanger is provided in the product water process circuit between the first heat exchanger and the inlet. Said third heat exchanger may serve for further cooling the product water, on account of which the temperature differential between the raw water coming from the evaporator and the product water injected into the condenser can be increased. On account thereof, the process of recovering product water that proceeds in the gas process circuit is accelerated. In some embodiments, the third heat exchanger may be supplied with a medium which has an ambient temperature since no additional investment in terms of energy is required for cooling said medium in this instance.

In some embodiments, the evaporator and/or the condenser are/is constructed so as to be multi-staged. This means that a plurality of stages are disposed on top of one another in the housing of the evaporator and/or of the condenser. Said stages can, for example, be composed of packings, the surfaces of the latter serving for the liquid medium (raw water or product water) to flow down thereon. The water, after passing through the packing, is collected and by way of a suitable installation is uniformly distributed before said water flows into the packing located therebelow. This installation for distribution can also be applied for atomizing the liquid, wherein no packings are required in this case. The multi-stage characteristic may enable intermediate heating of the product water, or intermediate cooling of the gas.

In some embodiments, the device is constructed from a plurality of stages, wherein a plurality of evaporators and condensers in pairs are in each case equipped with one product water process circuit and one gas process circuit. In other words, in each case one evaporator and one condenser result in at least two arrangements in pairs which can in each case operate in a mutually independent manner in interacting product water process circuits and gas process circuits. Each of the stages operates at other operating temperatures, wherein in the case of a use of more than two stages the neighboring stages operate at staggered operating temperatures. The neighborhood is thus defined in the context of the respective temperature differentials in the product water process circuit, or in the gas process circuit, respectively, and not by way of any potential physical neighborhood.

In some embodiments, the product water process circuits of neighboring stages are connected to a first connection line, wherein in the case of more than two product water process circuits a plurality of first connection lines are also provided. Moreover, a second connection line is provided between the bottom of one of the evaporators of a stage having a lower temperature level and the top of one of the evaporators of a neighboring stage having a higher temperature level. Here too, a plurality of second connection lines can be used in the case of more than two stages being used.

The first connection lines and the second connection lines may allow the individual stages to mutually communicate in that both product water as well as condensate, or raw water, respectively, can be forwarded from a stage having a cooler temperature level to a neighboring stage having a higher temperature level. The thermal energy of the respective fluids in the stage having the higher temperature level can be utilized such that cooling if at all is required not to the extent as would be required in the stage having the lower temperature level. The efficiency of the process can be further increased on account thereof.

The second connection lines lead to the tops of the evaporators. If no process circuit is provided for the raw water, part of said connection lines can also be configured by the line system of the process circuit. To this end, a suitable injection point which guarantees a connection has to be provided in the process circuit.

In some embodiments, one third heat exchanger is in each case disposed in each of the product water process circuits, wherein the third heat exchangers of neighboring stages are connected by a third connection line. Here too, it may be provided in the manner described that a heat transfer medium for cooling the product water is initially injected in the third heat exchanger of the coolest product water process circuit and then is in each case injected in stages into the third heat exchangers of the warmer product water process circuits. On account thereof, the heat transfer medium can achieve a cooling effect in each of the third heat exchangers.

In some embodiments, one second heat exchanger is in each case disposed in each of the lines leading to the evaporators (said lines potentially being part of a raw water process circuit), wherein the second heat exchanges of neighboring stages are connected by a fourth connection line. A heat transfer medium can be directed through said fourth connection line, said heat transfer medium discharging the process heat of an industrial process to the raw water, for example. The fourth connection line may be initially routed through the second heat exchanger for the hottest raw water and subsequently routed in stages through the second heat exchanger for progressively cooler raw water. The method specified can also particularly be carried out on a device of the type described. The advantages associated with said method have already been mentioned in the explanation of the device.

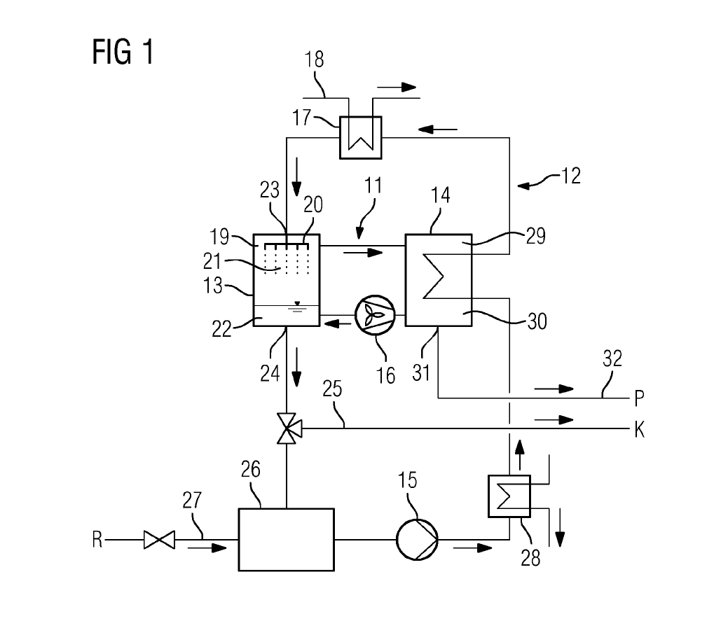

According to FIG. 1 a device having a gas process circuit 11 and a raw water process circuit 12 is illustrated. One evaporator 13 and one condenser 14 are connected in series in both process circuits, that is to say that said evaporators 13 and condensers 14 are passed through in an alternating manner. The raw water and the process gas circulate in opposing directions in the device such that an evaporation of the raw water in the evaporator 13 passes in the opposing direction through the process gas from the gas process circuit 11. The raw water in the raw water process circuit 12 is conveyed by a pump 15, and the gas (e.g., air) in the process gas circuit is conveyed by a blower 16. The respective flow directions are indicated by arrows.

In the raw water process circuit 12 the raw water is used as cooling medium in the condenser 13, wherein product water is fully condensed here from the process gas, and the raw water is heated on account thereof. The heated raw water is subsequently further heated in a second heat exchanger 17, wherein the latter by way of a connection line 18 is supplied with a heat transfer medium that carries process heat of an industrial process. The raw water thus heated is then injected by way of a top 19 of the evaporator 13, wherein a sprinkler installation 20 which generates a mist 21 of small droplets is provided in the top 19. The temperature of the raw water that flows downward in this manner drops from the top 19 to a bottom 20 of the evaporator because heat is extracted from the raw water by the evaporation of product water and by the heat transfer to the product gas. The temperature of the counterflowing process gas therefore rises from the bottom 22 to the top 19, but in the stable operation at static conditions always remains in each case below the temperature of the raw water at the same height level of the evaporator 13. On account thereof, the process gas can absorb more water vapor of the product water. The raw water and the process gas thus form a counter flow heat exchanger which operates according to the principle of direct evaporation.

The raw water thus makes its way into the evaporator by way of an infeed 23 and in terms of the impurities is concentrated by the evaporation of product water. Said raw water accumulates in the bottom 22 of the evaporator 13 and as concentrate exits the latter through an outfeed 24. Said concentrate can selectively be retrieved as concentrate K from the device by way of a retrieval line 25 or be fed into a storage tank 26 so as to complete a further pass in the raw water process circuit 12. Retrieved concentrate K, or evaporated product water, respectively, can be replaced by feeding new raw water R by way of an injection line 27.

The raw water furthermore is used for cooling the condenser 14. In order for a sufficiently high temperature differential to be implemented therefor, the raw water before being fed to the condenser 14 can by cooled by a fourth heat exchanger 28. The product water from the process gas which is injected into a top 29 condenses in the condenser. The drier process gas exits the condenser 14 through a bottom 30, while product water P can be retrieved by way of an outlet 31 in the condenser 14 and be discharged by way of a retrieval line 32.

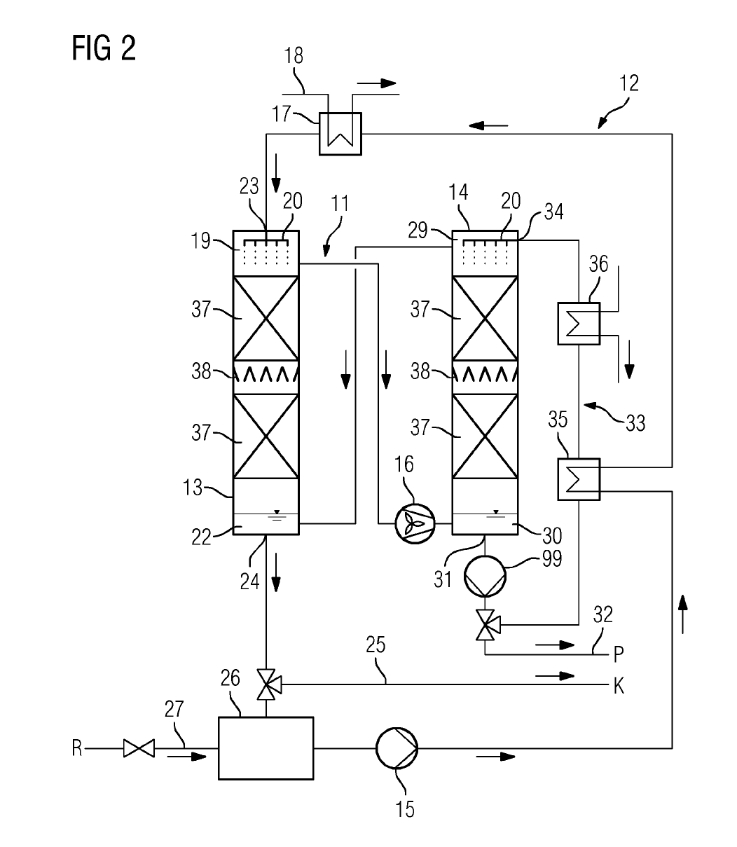

The device shown in FIG. 2 is largely constructed like the device according to FIG. 1, this being derived from the use of the same reference signs. However, a substantial point of differentiation lies in that a further process circuit, specifically a product water process circuit 33 that is operated by a pump 99, is provided. The condenser 14 is incorporated in this process circuit, wherein the product water is retrieved from the condenser 14 through the outlet 31 and after cooling is re-fed through an inlet in the top 29 of the condenser 14. Here too, a sprinkler installation 20 as in the evaporator 13 is provided, wherein the process gas flows counter to the sprinkled product water from the bottom 30 of the condenser to the top 29 of the condenser 14. Direct condensation of the product water located in the process gas is achieved on account thereof, wherein the condensed product water accumulates in the bottom 30.

Since the product water from the product water process circuit 33 is heated during condensation, said product water after retrieval from the outlet 31 has to be cooled. To this end, a first heat exchanger 35 is initially available, said first heat exchanger 35 being injected with the raw water in the raw water process circuit 12. The raw water in this manner can re-absorb the heat which by virtue of the evaporation in the evaporator 13 has been extracted from said raw water. This may lead to an increased efficiency of the method. The product water, after passing through the first heat exchanger 35, can pass through a third heat exchanger 36 in which said product water is further cooled by an external cooling source before being re-fed to the condenser 14 by way of the inlet 34. Depending on the prevailing temperature differentials, it would also be conceivable for the raw water to first be externally cooled and for the condensate process circuit (not illustrated) to be cooled by the cooled raw water.

As opposed to the illustration in FIG. 1, the evaporator 13 and the condenser 14 are in each case constructed so as to be multi-staged, wherein two packings 37 connected in succession are in each case used in the evaporator 13 and in the condenser 14. Since a heat transition through the material is not required because of the direct evaporation, or the direct condensation, respectively, said packings 37 can be manufactured from a chemically highly resistant plastics material, for example. Said material is moreover comparatively cost effective, which is why the production of the device becomes more economical. A water manifold 38 which collects in each case the product water or the raw water, respectively and subsequently distributes said product water or raw water, respectively, through a plurality of openings across the entire cross section of the evaporator 13 or the condenser 14, respectively, is in each case provided between the packings 37. Instead of the construction illustrated in FIG. 2, having packings, a construction of both the evaporator 13 as well as of the condenser 14 according to the construction illustrated in FIG. 1 is of course also possible, wherein the liquid according to FIG. 1 is sprinkled or atomized.

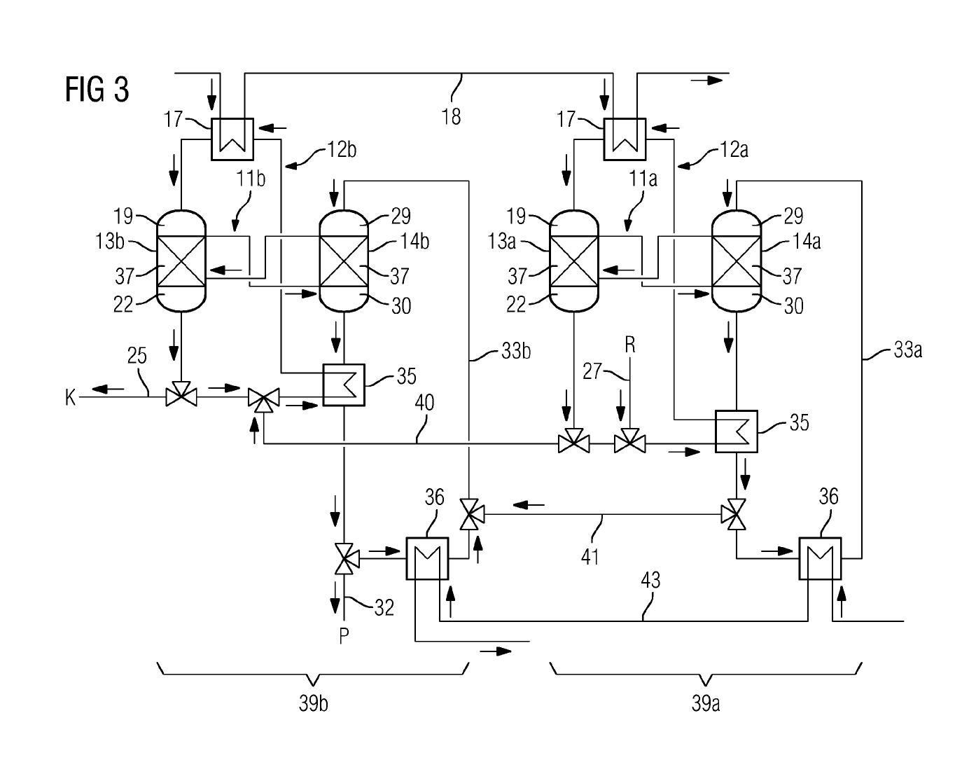

FIG. 3 shows a construction of the device in two stages 39a, 39b. Of course, more than the two stages illustrated can also be used, wherein the statements set forth hereunder can also be applied to triple-stage or multi-stage devices. For the sake of clarity, the pumps 15, blowers 16, and storage tanks 26 illustrated in FIGS. 1 and 2 have been omitted but are likewise present in order for the functioning of the device according to FIG. 3 to be guaranteed. The valves used in FIGS. 1 to 3 are not explained in more detail and therefore also not provided with reference signs. The opening and the closing of said valves depends on the respective functional state described and is therefore automatically derived.

The stage 39a as well as the stage 39b function like the device according to FIG. 2, even when only one packing 37 is in each case provided in the respective evaporators 13a, 13b, and condensers 14a, 14b. The stages 39a, 39b have in each case one raw water process circuit 12a, 12b, one gas process circuit 11a, 11b, and one product water process circuit 33a, 33b. In order for the efficiency to be increased, the raw water process circuit 12a and the raw water process circuit 12b are in each case connected to one another behind the evaporator 13a, 13b by way of a second connection line 40. Accordingly, the raw water R is injected into the raw water process circuit 12a by way of the injection line 27 and in a concentrated form exits said raw water process circuit 12a by way of the second connection line 40 so as to be fed to the raw water process circuit 12b. A further concentration of impurities is performed here in the evaporator 13b, wherein this concentrate K can be retrieved from the device by way of the retrieval line 25.

The two product water process circuits 33a, 33b are also connected to one another by way of a first connection line 41. A retrieval of product water is performed behind the first heat exchanger 35 in the product water process circuit 33a, said product water being re-fed to the product water process circuit 33b behind the third heat exchanger 36 (or the first heat exchanger 35, not illustrated) of the product water process circuit 35b. The product water obtained in the condenser 14a exits the product water process circuit 33a on said path. A retrieval of product water P from the product water process circuit 33b is performed by way of the retrieval line 32.

The forwarding of product water and raw water by way of the second connection line 40 or the first connection line 41, respectively, advantageously enables said raw water or product water, respectively, to be transferred from the stage 39a having an overall cooler operating temperature to the stage 39b having an overall higher operating temperature where the thermal energy stored in the product water or the raw water, respectively, can be utilized. This minimizes the overall investment that is associated with the cooling of raw water or product water, respectively, in the manner already described.

Moreover, the second heat exchangers 17 which are accommodated in the raw water process circuits 12a, 12b by way of the fourth connection line 18 can be connected in series in such a manner that the second heat exchanger 17 in the hotter stage 39b is passed through first, and the second heat exchanger 17 in the cooler stage 39a is passed through thereafter (and so forth in the case of more than two stages). The third heat exchangers 36 in the product water process circuits 33a, 33b by way of a third connection line 43 can be connected in series in exactly the same manner such that the third heat exchanger 36 in the cooler product water process circuit 33a is passed through first, and the third heat exchanger 36 in the warmer product water process circuit 33b is passed through thereafter (and so forth in the case of more than two stages). On account thereof, the heat exchange media are advantageously used in an optimal manner in that the respective residual heat, or residual cold, respectively, is still discharged in the neighboring stages 36a, 36b.

What is claimed is:

1. A device for separating product water which is obtained by condensation from raw water comprising a mixture of water and impurities, the device comprising:
a gas process circuit for a process gas, including an evaporator for the raw water and a condenser for the product water connected in series;
wherein the evaporator comprises an inlet for the raw water and an outlet for a concentrate which as compared to the raw water has a higher concentration of impurities to be separated;
wherein the condenser comprises an outlet for the product water;
a product water process circuit including the condenser and a first heat exchanger for cooling the product water connected in series; and
the condenser includes an inlet for the product water in a top of the condenser and the outlet for the product water in a bottom of the condenser; and
wherein the process gas flows from the bottom of the condenser to the top of the condenser.

2. The device as claimed in claim 1, wherein:
the inlet for the raw water is disposed in a top of the evaporator;
the outlet for the concentrate is disposed in a bottom of the evaporator; and
the process gas flows from the bottom of the evaporator to the top of the evaporator; and
the gas process circuit routes gas from the top of the condenser to the bottom of the evaporator and routes gas from the top of the evaporator to the bottom of the condenser.

3. The device as claimed in claim 1, wherein:
the first heat exchanger connects to a line for the raw water; and
the line passes through the first heat exchanger to routed to the inlet of the evaporator.

4. The device as claimed in claim 3, further comprising a second heat exchanger in the line between the first heat exchanger and the inlet of the evaporator.

5. The device as claimed in claim 1, further comprising a third heat exchanger in the product water process circuit between the first heat exchanger and the inlet of the condenser.

6. The device as claimed in claim 1, wherein at least one of the evaporator or the condenser comprises a multi-stage construction.

7. The device as claimed in claim 1, further comprising:
a plurality of stages including in each case a pair of an evaporator and a condenser with one product water process circuit and one gas process circuit;
wherein each of
the stages is configured to be operated at an temperature independent of the other stage;
the product water process circuits of neighboring stages are connected to a first connection line; and
a second connection line between the bottom of the evaporator associated with a stage having a lower temperature level and the top of one of the evaporators associated with a neighboring stage having a higher temperature level.

8. The device as claimed in claim 7, further comprising one third heat exchanger in each case disposed in the respective product water process circuit, wherein the third heat exchangers of neighboring stages are in each case connected by a third connection line.

9. The device as claimed in claim 7, wherein:
one second heat exchanger is disposed in each of the lines leading to the respective evaporator; and
the second heat exchangers of neighboring stages are in each case connected by a fourth connection line.

10. A method for separating product water which is obtained by condensation from raw water which is composed of a mixture of water and impurities, the method comprising:
delivering a process gas through a gas process circuit including an evaporator for the raw water and a condenser for the product water connected in series;
delivering the raw water to the evaporator by way of an infeed;
retrieving a concentrate which as compared to the raw water has a higher concentration of impurities to be separated from an outfeed of the evaporator;
retrieving product water from the condenser from an outlet;
wherein the condenser and a first heat exchanger for cooling the product water are connected in series within a product water process circuit; and
carrying out direct condensation in the condenser, wherein the product water is fed from an inlet into a top of the condenser, and exits from an outlet in a bottom of the condenser, and the process gas flows from the bottom of the condenser to the top of the condenser.

11. (canceled)

12. The method as claimed in claim 10, wherein:
the method is simultaneously carried out in a plurality of stages defined by a plurality of evaporators and condensers having in each case one product water process circuit and one gas process circuit are operated in pairs;
the respective stages are operated at independent temperatures;
the product water process circuits of neighboring stages are connected to a first connection line, wherein product water is transferred from the cooler to the hotter stage; and
a second connection line between the bottom of one of the evaporators of a stage having a lower temperature level and the top of one of the evaporators of a neighboring stage having a higher temperature level, wherein raw water is transferred from the cooler to the hotter stage.

13. (canceled)
